(19) United States
(12) Patent Application Publication
(10) Pub. No.: US 2006/0179005 A1
(43) Pub. Date: Aug. 10, 2006

(54) Network security system and methods regarding the same

(75) Inventors: Miles Li, Chongqing (CN); Xian-Fu Ren, Chongqing (CN)

Correspondence Address: ARENT FOX PLLC, 1050 CONNECTICUT AVENUE, N.W., SUITE 400, WASHINGTON, DC, 20036, US

(73) Assignee: FarStone Tech, Inc.

(21) Appl. No.: 11/347,384

(22) Filed: Feb. 6, 2006

(30) Foreign Application Priority Data
Feb. 4, 2005 (TW) 94103483

(51) Int. Cl. G06Q 99/00; H04L 9/00; H04K 1/00

(52) U.S. Cl. 705/64

(57) ABSTRACT

A network security system and methodology that securely defenses against current and future threats. According to the invention, anti-phishing method is utilized for protecting a computer system. In one embodiment of the invention, anti-phishing method comprises the steps of: detecting a user being submitting predetermined data to a predetermined website; intercepting the predetermined data; verifying whether address of the predetermined website is identical to an address of a secured website; and enabling and/or disabling the submission of the predetermined data.

### CROSS-REFERENCE TO RELATED APPLICATIONS

The present application claims priority, under 35 U.S.C. 119, to foreign application no. 94103483 filed Feb. 4, 2005 in Taiwan, the contents thereof are incorporated by reference herein by its entirety.

### BACKGROUND OF THE INVENTION

1. Field of the Invention

The present invention relates generally to a network security technique for anti-phishing, and more particularly to a network security system and method that securely defenses against phishing attacks.

2. Description of Related Art

Phishing is a process whereby fake web sites are used to trick you into thinking that you are interacting with a trusted site, a brand name, online retailer and bank or business partner site. The site then trick you into submitting your sensitive personal or financial information such as credit card numbers, account usernames and passwords, social security numbers, etc.

A common method is to send emails which direct you to what looks like a trusted website. They also can get you to their site when you simply click on a search result, when you use instant messaging or by planting spyware in your computer. Some phishing emails contain software that can harm your computer or track your activities on the Internet without your knowledge. Also, the fraud can be perpetrated very quickly, and afterward, the perpetrator can vanish into crowd quickly. So the phisher is not easy to be caught and punished.

On Jan. 10, 2004, a Citibank phishing email began making the rounds, warning Citibank customers of possible fraud affecting their accounts and urging them to login to check the status. Though email link takes the recipient to a website address that displays www.citibank.com in the browser address bar, in reality, the site is http://211.239.150.170/login/login.htm and records show it is hosted by Chang Hyo-Sun of Enterprise Networks in North Korea.

The email contains a button that reads “Click Here To Login”. Clicking the button appears to take the recipient to the web address www.citibank.com which instead is a criminal North Korean site.

Users are cheated to link to the fake web site at their home. Citibank suggested that “Delete suspicious e-mails without opening them”. However the typical phishing email is not a suspicious email at all. It tells us that Citibank has given the responsibilities to their customers to prevent phishing.

### BRIEF SUMMARY OF THE INVENTION

The present invention provides a network security system and method to resolve the foregoing problems faced by the conventional backup/recovery software. The present invention also has the advantage of providing high recognization from professed website address and actual browsed website address.

An object of the present invention is to provide a network security system and method, which can be downloaded and updated automatically.

Another object of the present invention is to provide a network security system and method preventing phishing, wherein the user will be alarmed if sensitive information is submitted in page of the actual browsed website.

A further object of the present invention is to provide a network security system and method, which can retrieve the actual browsed page contents and match keywords in a trusted list, so as to infer trusted website address, in order to make referrals to the users.

In accordance with an aspect of the present invention, a network security system for anti-phishing is suitable for a computer system. The security system comprises a detecting module, a processing module and a verifying module. The detecting module is for detecting a user being submitting predetermined data to a predetermined website. The processing module is for intercepting the predetermined data. The verifying module is for verifying whether address of the predetermined website is identical to an address of a secured website. The processing module enables and/or disables the submission of the predetermined data.

In the preferred embodiment of the invention, the predetermined data is private data. The predetermined website is E-commerce website. The network security system further comprises a database for keeping information of the secured website. The secured website is an official website. The verifying module analyzes and compares addresses of the predetermined website and the official website.

In accordance with another aspect of the present invention, an anti-phishing method comprises the steps of: detecting a user being submitting predetermined data to a predetermined website; intercepting the predetermined data; verifying whether address of the predetermined website is identical to an address of a secured website; and enabling and/or disabling the submission of the predetermined data.

In the preferred embodiment of the invention, the predetermined data is private data. The predetermined website is E-commerce website. Information of the secured website is kept in a database. The secured website is an official website. The anti-phishing method further comprises the step of analyzing and comparing addresses of the predetermined website and the official website. The present invention may best be understood through the following description with reference to the accompanying drawings, in which:

### BRIEF DESCRIPTION OF THE DRAWINGS

FIG. 1 shows a schematic block diagram of a network security system of a preferred embodiment according to the present invention; and

FIG.2 shows a schematic flow chart of an anti-phishing method of the preferred embodiment according to the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purpose of illustration and description only. It is not intended to be exhaustive or to be limited to the precise form disclosed.

The present invention describes a new anti-phishing technique for a network security system to recognize whether the professed website address is an official website of a reliable organization. With the security technique of the present invention, the users can securely defenses against phishing and spoofing.

According to the preferred embodiment of the present invention, a network security system for anti-phishing is suitable for a computer system. The security system comprises a detecting module, a processing module and a verifying module. The detecting module is for detecting a user being submitting predetermined data to a predetermined website. The processing module is for intercepting the predetermined data. The verifying module is for verifying whether address of the predetermined website is identical to an address of a secured website. The processing module enables and/or disables the submission of the predetermined data.

The predetermined data is private data. The predetermined website is E-commerce website. The network security system further comprises a database for keeping information of the secured website. The secured website is an official website. The verifying module analyzes and compares addresses of the predetermined website and the official website.

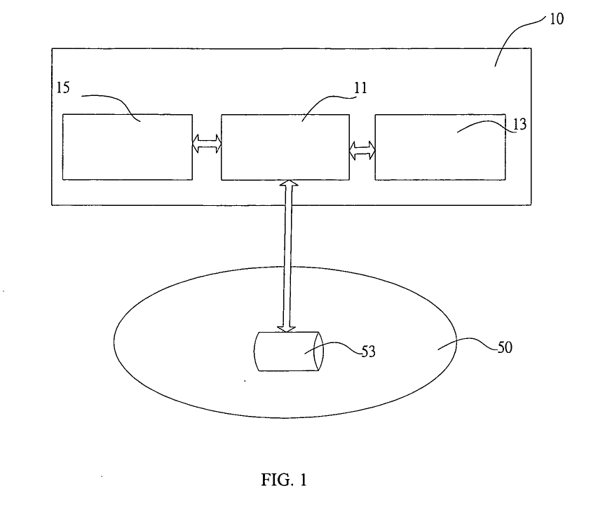

Referring to FIG. 1, a schematic block diagram of a network security system of a preferred embodiment according to the present invention is shown. The network security system 10 is used for anti-phishing. The network security system 10 of the present invention is suitable for a computer system. The security system 10 comprises a detecting module 15, a processing module 13 and a verifying module 11.

The detecting module 15 is for detecting a user being submitting predetermined data to a predetermined website. The predetermined website is E-commerce website. The processing module 13 is for temporarily intercepting the predetermined data. The predetermined data is private data. The verifying module 11 is for verifying whether address of the predetermined website is identical to an address of a secured website.

The address of the E-commerce website can be get from user input. User may input the Uniform Resource Locators (URL) in the received email. Alternatively, the visiting address of the E-commerce website can be get while monitoring the submission of the private data through the Internet Explorer.

If the E-commerce website belongs to a real bank or organization, it provides an official website. The network security system may comprise a live update database 50 for keeping information of the secured website. The secured website is the official website. The live update database may generate a trusted list 53 for determining a user credible website.

Prior to the submission of the private data, the user is to be prompted for the trusted list 53. The user may select a secured website from the trusted list 53. Also, the network security system 10 of the present invention may analyze the website which is being currently surfing by the user.

The network security system 10 of the present invention may retrieve the browsed page contents and match keywords in the trusted list 53. For example, the currently page contents consists of the word “account”, the network security system 10 deems that it was a private data concerning bank account. The network security system 10 may alarm the user while submission of such page.

The network security system 10 of the present invention may infer trusted website address of the visiting website to make referrals to the users. The verifying module 11 analyzes and compares addresses of the visiting website and the official website. For example, the IP address is identical; the processing module 13 may enable the submission of the private data. The accurate IP address of the reliable website can be kept in the database 50.

According to the preferred embodiment of the present invention, an anti-phishing method comprises the steps of: detecting a user being submitting predetermined data to a predetermined website; intercepting the predetermined data; verifying whether address of the predetermined website is identical to an address of a secured website; and enabling and/or disabling the submission of the predetermined data.

The predetermined data is private data. The predetermined website is E-commerce website. Information of the secured website is kept in a database. The secured website is an official website. The anti-phishing method further comprises the step of analyzing and comparing addresses of the predetermined website and the official website.

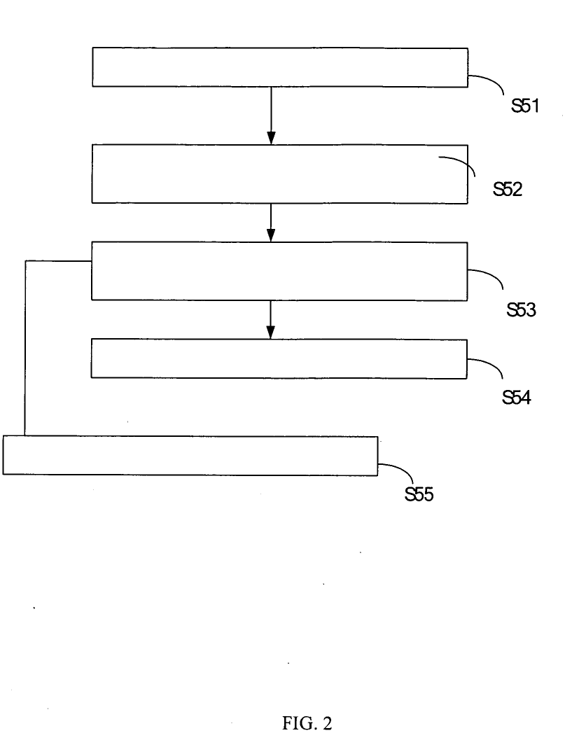

Referring to FIG. 2, a schematic flow chart of an anti-phishing method of the preferred embodiment according to the present invention is shown. According to the present invention, the anti-phishing method of the present invention is suitable for a computer system.

In step S51, the user inputs her or his private data to a browsed page of an E-commerce website. The network security system of the present invention detects the user is going to submit data out. In step S52, the network security system intercepts the data submission.

In step S53, the network security system analyzes and compares addresses of the visiting website and the official website. Information of the secured website is kept in a database. The secured website is an official website.

If the IP address is identical; then the processing module 13 enables the submission of the private data in step S54. The accurate IP address of the reliable website can be kept in the database 50. Otherwise, the processing module 13 disables the submission of the private data in step S55.

The present invention can protect online banking users and Financial Institutions against such a wide variety of threats so that personal data theft from fraudulent Web sites can effectively be solved. The shortcoming that the foregoing problems faced by the conventional phishing emails and bogus websites can be entirely avoided.

The network security system according to the present invention can prohibit from sending sensitive on-line banking account information to the bogus websites. Hence, the network security system of the present invention not only can protect users against online scams such as phishing and spyware but also can guard the organization from potential Legal issues resulting from problematic outbound email.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures.

1. A network security system for anti-phishing, suitable for a computer system, said security system comprising:
a detecting module for detecting a user being submitting predetermined data to a predetermined website;
a processing module for intercepting said predetermined data; and
a verifying module for verifying whether address of said predetermined website is identical to an address of a secured website,
wherein said processing module enables and/or disables said submission of said predetermined data.

2. The network security system according to claim 1, wherein said predetermined data is private data.

3. The network security system according to claim 1, wherein said predetermined website is E-commerce website.

4. The network security system according to claim 1, further comprising a database for keeping information of said secured website.

5. The network security system according to claim 4, wherein said secured website is an official website.

6. The network security system according to claim 5, wherein said verifying module analyzes and compares addresses of said predetermined website and said official website.

7. An anti-phishing method comprising the steps of:
detecting a user being submitting predetermined data to a predetermined website;
intercepting said predetermined data;
verifying whether address of said predetermined website is identical to an address of a secured website; and
enabling and/or disabling said submission of said predetermined data.

8. The anti-phishing method according to claim 7, wherein said predetermined data is private data.

9. The anti-phishing method according to claim 7, wherein said predetermined website is E-commerce website.

10. The anti-phishing method according to claim 7, wherein information of said secured website is kept in a database.

11. The anti-phishing method according to claim 10, wherein said secured website is an official website.

12. The anti-phishing method according to claim 11, further comprising the step of analyzing and comparing addresses of said predetermined website and said official website.
